(19) United States
(12) Patent Application Publication
(10) Pub. No.: US 2005/0047496 A1
(43) Pub. Date: Mar. 3, 2005

(54) Modem with pilot symbol synchronization

(76) Inventors: William K. McIntire, Sandy, UT (US); Dale D. Fonnesbeck, Kaysville, UT (US); Osama S. Haddadin, Salt Lake City, UT (US)

Correspondence Address: PERMAN & GREEN, 425 POST ROAD, FAIRFIELD, CT, 06824, US

(21) Appl. No.: 10/640,190

(22) Filed: Aug. 13, 2003

(51) Int. Cl. H04B 1/38

(52) U.S. Cl. 375/222

(57) ABSTRACT

A modem, or a communication system, in its transmission section, has signal-formatting circuitry followed by circuitry for insertion of a sequence of pilot symbols into a sequence of data symbols outputted by the formatting circuitry. Placement of the insertion circuitry after the formatting circuitry permits a variety of formatting options without effecting the sequence of pilot symbols that serves as a time reference useful in detection of a signal transmitted by the modem. The reception section of the modem is equipped correspondingly to process a received composite signal of data symbols having a prescribed format and a sequence of pilot symbols. The reception section extracts the sequence of pilot symbols from the composite signal, and employs the pilot symbols to develop a time base for operation of circuitry for decoding the format of the received composite signal to extract data from the composite signal.

### BACKGROUND OF THE INVENTION

1. Field of the Invention

This invention relates to a construction of a modem employing an inserted pilot symbol(s) for improved synchronization and equalization of demodulation circuitry within the modem and, more particularly, to the insertion of pilot symbols at a location within the transmitted symbol stream permitting use of the pilot symbols independently of the type of modulation applied to payload data.

2. Brief Description of Related Developments

Communication systems are widely used in many situations including communication between persons, as in cellular telephony, and between various forms of equipment, such as between a satellite and a ground station. Various data formats and protocols have evolved to facilitate communication in differing situations. Communication may involve multiple access technologies such as CDMA (code division multiple access), TDMA (time division multiple access), FDMA (frequency division multiple access), modulation technologies such as PSK (phase shift keying), QAM (quadrature amplitude modulation), and FEC (forward error correction) such as Reed Solomon coding, convolutional encoding, and turbo coding, by way of example. Detection of such signals may require a highly accurate time base for observation of relatively small differences in phase of a carrier signal, phase of the symbol and phase of the multiplexer frame. Furthermore, the time base employed in a receiver of a signal must be the same as the time base (synchronous) employed in a transmitter of the signal in order to enable successful operation of receiving processes (demodulation operation), such as matched filtering, by way of example. In the case of a communication system employing a modem at each end of a communication link, such as a link connecting two computers for enabling communication between the two computers, it is necessary to include within each of the modems circuitry for transmitting synchronization or time-frame signals and circuitry for recognizing received synchronization or time-frame signals.

A further consideration in the design of a communication system is the capacity of the system to reacquire phase synchronization, symbol timing and frame timing in the event of a momentary loss of transmitted signal as might occur if an obstacle, which can block transmission, momentarily passes across the communication link. It is of considerable advantage to provide for a rapid reacquisition so as to minimize any interruption in the communicated data. As a further consideration, a communication system may include a specific form of pilot symbol with the transmitted signal as an aide to acquisition of the aforementioned phase synchronization, symbol timing and frame timing. Additionally the communication system may have the feature of adaptive modulation wherein the modulation of the data symbols may be altered from time to time. This would present a problem if the data modulation is employed also for modulation of pilot symbols because the receiver might not be able to locate the pilot symbols due to the changing modulation. Therefore, it is advantageous to provide for pilot symbols which are constant and independent of modulation employed for the data symbols so that the receiver can track the pilot symbols independently of changes in the data modulation.

In order to obtain accurate reception of data transmitted by a communication system, presently available communication equipment may employ elaborate circuitry in a receiver of the communication system to regenerate a time frame employed in a transmitter of the communication system. In some cases, a synchronization pulse may be transmitted along with the data to serve as a time base for reception of the data. This presents a problem in the case of a noisy communication link because the precise location, in time, of the synchronization pulse may be difficult to ascertain with a resulting degradation in the quality of reception of the data.

### SUMMARY OF THE INVENTION

The aforementioned problem is overcome and other advantages are provided by transmission of a sequence of pilot symbols, or a pilot word, along a communication link to accompany the transmission of data along the communication link, in accordance with the invention, to establish an accurate and precise time base to which the receiving circuitry can synchronize the receiver timing. Thereby, the receiving equipment can be precisely synchronized with the sequence of bits which constitutes the received data. The invention can also be implemented in the construction of modems, as may be employed at the terminals of the communication link. In such modem, the pilot symbols are inserted into the transmission (modulation) section for combining with data symbols, and are employed in the reception (demodulation) section of the modem as a reference for detection of the data symbols.

The disclosed embodiments enable use of the pilot symbols in a communication system in a manner which is compatible with operation of the communication system with any one of a plurality of modulation protocols and formats, such as those noted above. This is accomplished, in accordance with a feature of the invention, by including in the transmitter a location for insertion of the pilot symbols at a point subsequent to the conclusion of the specific form of modulation or formatting, such as subsequently to the implementation of a QAM or a PSK, by way of example.

In a typical construction of the transmission section of a communication system, digitized data, obtained from a source of data, is encoded by a suitable forward error correction code and then applied to a constellation mapper that provides any one of well known mappings for modulations such as BPSK, QPSK, QAM and FSK, by way of example. The data source, by way of example, may be a computer outputting digitized data, or speech-processing circuitry that converts voice into a digitized signal. A sequence of pilot symbols constituting a pilot word is stored in a memory of the transmission section, and the pilot word is also outputted to a constellation mapper providing one of the foregoing modulations. The modulated data and the modulated pilot symbols are multiplexed together to provide output sequences of pilot symbols interposed among sequences of data symbols. Thus, the multiplexing takes place after the pilot symbols and the data symbols are separately modulated. Therefore, an interleaving of sequences of pilot symbols with sequences of data symbols does not interfere with the formatting and modulation of the data signals. Thus, the present invention can be employed without derogating from the usual performance of the communication system.

At the receiver, the sequence of the pilot symbols is detected, as by use of a matched filter or a correlation process employing a replica of the sequence of the pilot symbols. In the practice of the invention, the length of the sequence of pilot symbols affects acquisition time such that a longer sequence provides for a faster determination of carrier phase, symbol timing and block or frame timing. The resulting estimates of carrier phase, symbol timing and block or frame timing are less noisy and more reliable. An increase in the length of the sequence of pilot symbols may detract from the amount of space available for sequences of data symbols so that, in practice, a trade-off may be necessary. In particular, the timing accuracy provided by the sequence of pilot symbols is sufficient for determining unambiguous carrier phase, symbol timing, block timing, and other parameters of the data transmission. The pilot symbol may also include codes or information useful for resetting a receiver, if desired. By way of example, this may include informing a receiver of switching data rate or modulation type. Thus, the invention rapidly and reliably establishes a time base with carrier phase and timing synchronization useful for equalization filter training, modem configuration switching, and turbo code synchronization, by way of example.

### BRIEF DESCRIPTION OF THE DRAWING

The aforementioned aspects and other features of the invention are explained in the following description, taken in connection with the accompanying drawing figures wherein:

FIG. 1 is a block diagram of a communication system employing the pilot symbol sequence in accordance with the invention;

FIG. 2 is a timing diagram useful in explaining operation of the system of FIG. 1;

FIG. 3 is a block diagram of a modem employing the pilot symbol sequence in accordance with the invention;

FIG. 4 shows further details in demodulator circuitry for use in either the system of FIG. 1 or the modem of FIG. 3; and

FIG. 5 shows circuitry for detection of pilot symbols in the demodulator of FIG. 4.

Identically labeled elements appearing in different ones of the figures refer to the same element but may not be referenced in the description for all figures.

### DETAILED DESCRIPTION OF THE INVENTION

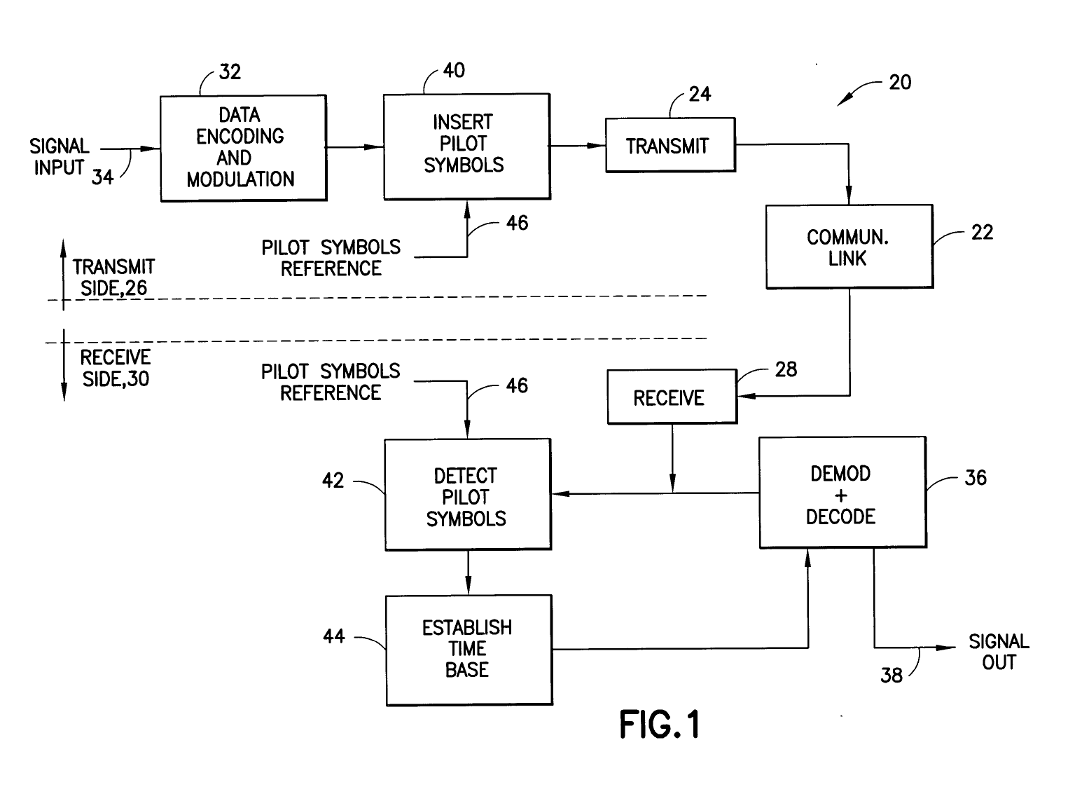

With reference to FIG. 1, a communication system 20 includes a communication link 22 connecting a transmitter 24, on a transmit side 26 of the link 22, with a receiver 28 on a receive side 30 of the link 22. Also included on the transmit side 26 is formatting circuitry 32, which includes coding circuitry (not shown in FIG. 1), for encoding and formatting an input signal, applied at an input terminal 34, as well as modulation circuitry (not shown in FIG. 1). The modulation circuitry and the encoding circuitry provides for a variety of signaling formats such as, by way of example, CDMA, TDMA, PSK, QAM, Reed Solomon coding, convolutional encoding and Turbo coding. More specifically, such circuitry provides data processing or formatting for error correction and phase ambiguity resolution for multiuser (TDMA, FDMA and CDMA), spread spectrum by direct sequence (DS) or frequency hopped (FH), and modulation/signaling (PSK, QAM, MSK). The formatting circuitry 32 may comprise a set of ASICs (Application Specific Integrated Circuits) of which an individual ASIC provides a specific form of the signal formatting, or may comprise programmable circuitry such as a DSP (Digital Signal Processor) or a FPGA (Field Programmable Gate Array) operative with any one of several programs which may be selected to provide the desired signal formatting. Limited programming may be provided in the ASIC if additional circuitry for the additional functions is built into the ASIC. The formatted signal is transmitted by the transmitter 24 through the communication link 22 to the receiver 28. At the receive side 30, the communication system 20 includes circuitry 36 connecting with an output of the receiver 28 for accomplishing a demodulation and a decoding of the transmitted signal to regain the data symbols of the signal at terminal 34. The data symbols retrieved by the demodulation and decoding circuitry 36 are output at terminal 38.

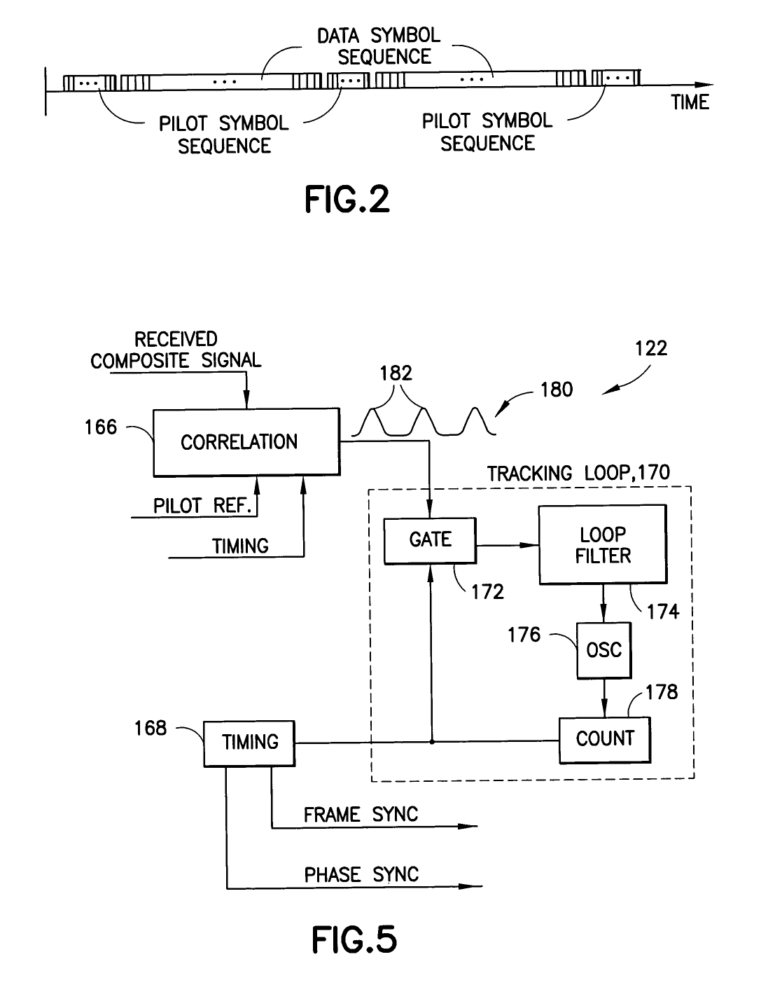

In accordance with a feature of the invention, a sequence of pilot symbols is transmitted along with the sequence of data symbols via the communication link 22 to establish a time base, as well as provision for carrier estimation and equalizer training, for improved accuracy and fast acquisition in the operation of the demodulation and decoding circuitry 36. At the transmit side 26, pilot symbols are inserted into a train of formatted data symbols by insertion circuitry 40 located between the formatting circuitry 32 and the transmitter 24. The insertion circuitry 40 operates to interleave sequences of pilot symbols among sequences of data symbols as is shown in FIG. 2. By way of example, a sequence of the data symbols may have one thousand symbols while a sequence of the pilot symbols may have 50 symbols. Since the sequence of pilot symbols does not pass through an FEC or other processing that operates on the data stream, the invention provides for flexibility in the design of the sequence of pilot symbols such that the sequence of pilot symbols can have any modulation format independently of the data sequence. It is understood that other lengths of the pilot symbol and data symbol sequences may be employed, and that a longer length of pilot symbol sequence produces greater accuracy in a time base constructed from the sequence of pilot symbols than does a shorter pilot symbol sequence. On the receive side 30 of the communication system 20, a detector 42 of the pilot symbols extracts the symbols from the receive signal, outputted by the receiver 28, and applies the detected symbols to timing circuitry 44 for establishment of a time base to operate the demodulation and decoding circuitry 36.

Operation of the detector 42 is based on matched filtering of the received signal or of correlation of the received signal against a reference sequence of the pilot symbols or, alternatively, other pattern recognition techniques using absolute difference or MSE. Successful correlation requires that the reference sequence employed in the correlation operation of the detector 42 be the same as the reference sequence employed by the insertion circuitry 40. This is indicated diagrammatically by providing the sequence of pilot symbols from a common reference 46. In practice, this means communicating the reference sequence of pilot symbols, which is employed at the insertion circuitry 40, to the receive side 30 of the communication system 20 prior to a communication of data via the link 22. Alternatively, the reference sequences of pilot symbols can be stored in memories, indicated in phantom at 46A and 46B, wherein the reference sequences of pilot symbols are provided during the construction of the system 20.

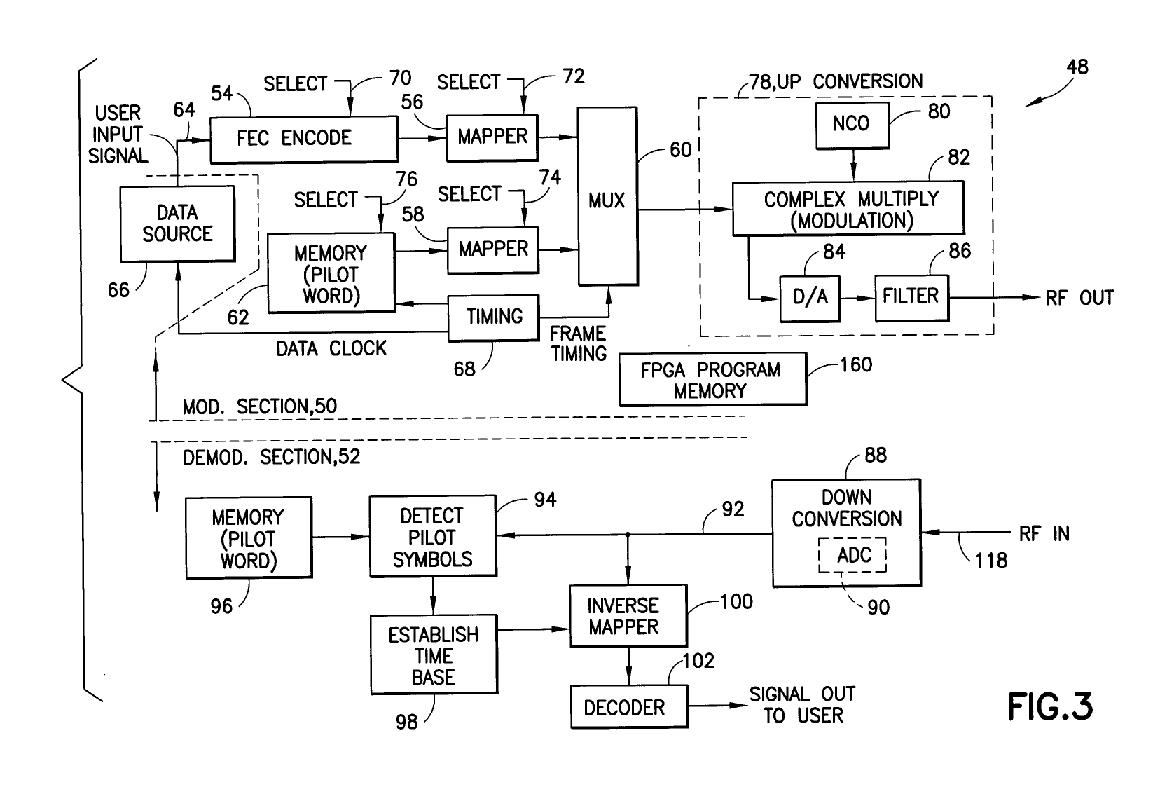

The description of the communication system 20 in FIG. 1 presents a one-way communication of data from the transmitter 24 to the receiver 28. For two-way communication, a modem having both modulation and demodulation sections may be placed on the transmit side 26 and a second such modem may be placed on the receive side 30 for two-way communication via the communication link 22. For each of the modems, the modulation section of the modem would have equipment providing the function of the transmit side 26 of FIG. 1, and the demodulation section of the modem would have equipment providing the function of the receive side 30 of FIG. 1. A suitable modem 48 is shown in FIG. 3.

With reference to FIG. 3, the modem 48 comprises a modulation section 50 and a demodulation section 52. The modulation section 50 comprises an FEC encoder 54, two constellation mappers 56 and 58, a multiplexer 60 and a memory 62 storing a pilot word. An input signal of a user is applied to terminal 64 to be encoded by the encoder 54 with an error correction code, and the coded signal outputted from the encoder 54 is applied to the mapper 56 to receive a modulation in the form of BPSK, QPSK, QAM, or FSK, by way of example. The bits of the coded signal are mapped by the mapper 56 into I and Q components. By way of example, in BPSK, one bit generates one symbol. In QPSK, two bits generate one symbol (as represented by the I and the Q components). And in 8PSK, three bits generate one symbol. The modulated signal produced by the mapper 56 is applied to the multiplexer 60. The user input signal is provided by a data source 66, which may be a computer providing digitized data or telephony equipment providing digitized voice signals, by way of example.

A sequence of pilot symbols constituting a pilot word is stored in the memory 62 and is outputted via the mapper 58 to the multiplexer 60. The mapper 58 is operative in the same manner as the mapper 56 to provide any of a plurality of modulations. The choice of pilot symbol mapping for the mapper 58 is independent of the type of mapping chosen for the data at the mapper 56. A timing unit 68 provides timing signals for synchronizing operations of the data source 66 with the memory 62 and the multiplexer 60, the timing signals including a data clock applied to the data source 66 and a frame timing applied to the multiplexer 60. The encoder 54, the mapper 56, the mapper 58, and the pilot-word memory 62 include respective terminals 70, 72, 74 and 76 by which, respectively, the encoder 54 is enabled to select one of a plurality of codes, the mapper 56 is enabled to select one of a plurality of modulations, the mapper 58 is enabled to select one of a plurality of modulations, and the memory 62 and is enabled to select one of a plurality of previously stored pilot words. In the operation of the modem 48, the timing unit 68 strobes alternately the data source 66 and the pilot word memory 62 to output from the multiplexer 60 the alternating sequence of data symbols and pilot symbols, shown in FIG. 2.

Also included in the modem 48 is an up-conversion unit 78 comprising a numerically controlled oscillator (NCO) 80, a complex multiplier 82, a digital-to-analog converter 84, and a filter 86. The up-conversion unit 78 is operative to translate the signal outputted via the multiplexer 60 up to an RF (radio frequency) signal to be outputted by the modulation section 50 of the modem 48. In the operation of the up-conversion unit 78, the oscillator 80 outputs a signal at a predesignated frequency to the multiplier 82. The multiplier 82 multiplies the in-phase and quadrature (I and Q) components of the symbols outputted via the multiplexer by the signal outputted via the oscillator 80 to produce the digital equivalent of the RF output signal. The digitized signal at the output of the multiplier 82 is then converted to an analog signal by the converter 84 and filtered by the bandpass filter 86 to produce a sinusoidal waveform with modulation corresponding to the modulation imparted by the constellation mappers 56 and 58, and with a carrier frequency corresponding to the frequency of the oscillator 80.

In the demodulation section 52, the modem 48 has a down-conversion subsystem 88 with an analog-to-digital converter 90 which, upon receipt of an input RF signal, converts the input RF signal from analog format to digital format. The down-conversion subsystem 88 includes digital components, as will be described hereinafter, for outputting on line 92 a baseband digital signal having the general form of the signal produced by the multiplexer 60 and described in FIG. 2 wherein there are sequences of data symbols interleaved among sequences of pilot symbols. Also included in the demodulation section 52 of the modem 48 are a pilot symbol detector 94, a memory 96 for storing a reference pilot word to be used by the detector 94 in the detection of pilot symbols in the signal on line 92, circuitry 98 responsive to the presence of the pilot symbols for establishing a time base for use in extracting the data symbols from the signal on line 92, an inverse mapper 100 which operates in a manner inverse to the operation of the mapper 56 to demodulate the retrieved data symbols, and a decoder 102 operative in a manner inverse to the operation or the encoder 54 for decoding the data symbols.

Thus, in the operation of the demodulation section 52, the detector 94 is able to detect the presence of the pilot symbols on line 92. The time base circuitry 98 establishes a time base, based on the presence of the pilot symbols, for extraction of the data symbols from line 92. The reference sequence of pilot symbols to be employed by the detector 94 is to be the same as that employed in a distant modem communicating with the modem 48. By use of the time base, the inverse mapper 100 and the decoder 102 are able to demodulate and to decode the data symbols so as to recover the data and to output the data to the user of the modem.

Upon comparing the operation of the modem 48 in FIG. 3 with the operation of the system 20 in FIG. 1, it is apparent that the operation of the modulation section 50 corresponds to the operation of the transmit side 26. Both the modulation section 50 and the transmit side 26 provide for an encoding of the data and the provision of interleaved sequences of data symbols with pilot symbols. Also, the operation of the demodulation section 52 corresponds to the operation of the receive side 30. Both the demodulation section 52 and the receive side 30 detect the presence of the pilot symbols for the establishment of a time base, and the utilization of the time base for the modulation and decoding of the data symbols to retrieve the data, as well as for equalizer training, phase estimation, and modem configuration switching, by way of example.

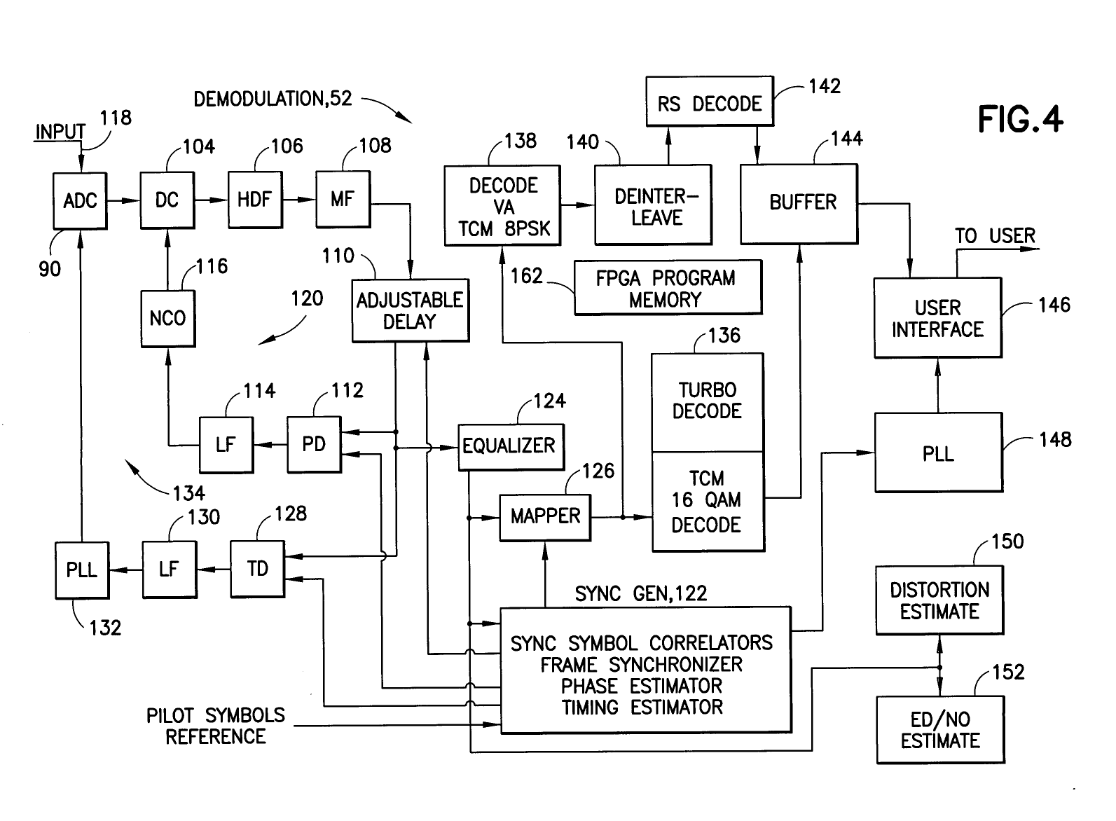

FIG. 4 provides a more detailed description of demodulation section 52 of the modem 48 of FIG. 3, which description applies also to the demodulation portion of the receive side 30 of FIG. 1. In FIG. 4, the demodulation section 52 comprises the analog-to-digital converter 90, a down conversion unit 104, a filter 106 for limiting the bandwidth of the signal and including a high amount of decimation of the signal samples, a matched filter 108, an adjustable delay unit 110, a phase error detector 112, a loop filter 114, and a numerically controlled oscillator 116. An input signal at terminal 118 (shown also in FIG. 3) is converted by the converter 90 from an analog signal to a digital signal, and then is down-converted to baseband by the down-conversion unit 104 upon a mixing of the signal with a reference signal from the oscillator 116. Thereupon, the signal passes to the filter 106 for removal of any spectral components lying outside of its desired bandwidth, as well as removal of a DC component. The filter 106 includes variable decimation circuitry for deleting excess samples of the filtered signal. Thereupon, the signal is detected by the matched filter 108. The precision in the operation of the matched filter 108 is dependent on the alignment of the reference signal from the oscillator 116 applied to the circuit 104, the alignment being controlled by a loop 120 consisting of the circuit 104 and the oscillator 116, along with the filter 106, the filter 108, the delay unit 110, the detector 112, and the filter 114.

The loop 120 is the carrier phase and frequency recovery loop. In the operation of the loop 120, a synchronization generator 122 outputs a signal for control of the delay of the delay unit 110, and outputs a further signal which serves as a reference signal for operation of the phase error detector 112. The delay of the unit 110 is adjusted to provide for alignment of the signal outputted by the oscillator 116 with the signal outputted by the converter 102. The delayed signal, outputted by the delay unit 110, is compared with the phase reference at the detector 112 which outputs a signal to the loop filter 114 indicating the error in phase or alignment of the two signals applied to the detector 112. The loop filter 114 applies the phase error to a control terminal of the oscillator 116 to adjust the frequency and phase of its output signal. The loop filter 114 operates in a well-known fashion to control the dynamic stability of the loop 120.

The output signal of the delay unit 110 is applied via an equalizer 124 to a mapper 126 and to the synchronization generator 122. The function of the equalizer 124 is to remove distortion in the signals received by the matched filter 108, this function being particularly useful in the case of received signals having the 16-QAM format. Upon receipt of the signal from the equalizer 124, the synchronization generator 122 is able to generate various timing signals, synchronized with the signal of the equalizer 124, the timing signals being indicative of carrier phase, symbol timing and frame timing.

The demodulation section 52 further comprises a time error detector 128, a further loop filter 130 and a phase-locked loop (PLL) 132. The signal outputted by the delay unit 110 is applied, along with a timing reference signal from the generator 122, as input signals to the detector 128. The detector 128 uses these two signals to compute a timing error, and outputs a signal via the loop filter 130 to the PLL 132 indicative of the time error between the signals of the delay unit 110 and the generator 122. The PLL 132 outputs a periodic waveform, such as a sine wave or a square wave, that serves as a clock signal for operation of the analog-to-digital converter 90. The detector 128, the filter 130 and the PLL 132 are part of a further loop 134 which functions as a timing synchronization loop. In the preferred embodiment of the invention, the pilot symbols have the same symbol rate as do the data symbols so that, upon a locking of the PLL 132 to the input signal at terminal 118, the strobing of the converter 102 is operative equally for recovery of both the data symbols and the pilot symbols.

The synchronization generator 122 is provided also with the pilot symbols reference, which may be provided by the pilot memory 96 of FIG. 3, or may be stored within the synchronization generator 122, by way of example. The synchronization generator 122 employs the reference sequence of pilot symbols to detect the occurrences of the pilot symbol sequences in the composite signal of pilot symbol sequences interleaved with the data symbol sequences outputted by the equalizer 124. This will be explained further with reference to FIG. 5. As shown in FIG. 4, the generator 122 provides a timing signal to the mapper 126 to perform the inverse function of the constellation mapping, thereby to prepare the received signal for the following process of removal of formatting, such as the formatting provided by the formatting circuitry 32 of FIG. 1.

FIG. 4 also shows various decoding blocks which may be employed for decoding various formats which may be applied to the input signals received at terminal 118. These blocks include a decoder 136 having a section for turbo decoding and a decoding of TCM (trellis coded modulation) 16-QAM, a decoder 138 employing a Viterbi algorithm for TCM 8-PSK, an inter-code de-interleaver 140, a Reed-Solomon decoder 142, a buffer store 144, a user interface 146 and a PLL 148. The signal outputted by the mapper 126 may be applied to the detector 136 to accomplish the turbo decoding or a decoding of TCM 16-QAM, the decoder signals then being applied to the buffer store 144. Alternatively, the signal of the mapper 126 may be applied to the decoder 138 and then via the de-interleaver 140 to the Reed-Solomon decoder 142 to accomplish the decoding operations of the decoders 138 and 142. The signals outputted by the decoder 142 are applied to the buffer store 144. The PLL 148 is driven by a timing signal of the generator 122 to output strobe signals to the interface 146. The data stored in the buffer store 144 is made available to a user by the interface 146, wherein the interface 146 may provide for additional formatting beneficial to the user. The signal outputted by the equalizer 124 is applied also to circuitry 150 providing for an estimate of distortion in the signal, and to circuitry 152 which provides an estimate of signal pilot to noise power on a per-symbol basis. This information is useful for a determination of the accuracy of the data being received by the demodulation section 52.

Also, it is noted that certain portions of the equipment can be fabricated by FPGAs. Thus, all digital processing can be accomplished in the FPGA. The use of the FPGA is preferred in the construction of the invention because it enables one piece of equipment to be employed for handling any one of several possible formatting options. Alternatively, a DSP may be employed for a reduced throughput speed but increased programming capability. An ASIC may also be employed for maximum throughput speed in the situation wherein only a single format is anticipated, or also in any of a plurality of formats if the ASIC is constructed with the additional circuitry required for carrying forth the additional formats. In the cases of the FPGA and the DSP, optional coding and modulation may be provided for by including in memories of the FPGA and of the DSP instructions for the optional coding and modulation. By way of example, in FIG. 3, the encoder 54, the two mappers 56 and 58, and the multiplexer 60 may be fabricated as an FPGA wherein the FPGA includes a memory 160 with instructions for implementing various forms of coding and modulation. Similarly, the filters, detectors and the decoders of FIG. 4 can be fabricated as an FPGA wherein a memory 162 stores the programming for implementing various forms of demodulation and decoding. In the event that a DSP or an ASIC is employed, the memories 160 and 162 would store the instructions for the operations of the DSP or ASIC.

With reference to FIG. 5, there is shown a portion of the synchronization generator 122 of FIG. 4, the portion including a correlator 166, a timing unit 168, and a tracking loop 170. The tracking loop 170 includes a gate 172, a loop filter 174, an oscillator 176 and a counter 178. The circuitry of FIG. 5 is provided by way of example to demonstrate a construction of the synchronization generator 122 for utilization of the pilot symbol sequence to obtain an accurate time base for demodulating the received composite signal of interleaved sequences of data and pilot symbols. The received composite signal is correlated with the pilot reference sequence at the correlator 166 to obtain an output signal, indicated in stylized fashion at 180, wherein peaks 182 provide an accurate indication of the times of the occurrences of the pilot symbol sequence in the received composite signal. The signal 180 is applied to the gate 172, wherein a gating signal is also applied to the gate 172 by the counter 178. At the gate 172, the two signals applied to the gate are multiplied together to provide an error signal which is outputted via the loop filter 174 to the oscillator 176. The error signal drives the oscillator 176 to provide its output signal with a phase and a frequency that minimizes the loop error signal. The loop filter 174 provides dynamic stability to the loop 170. The oscillator 176 operates at relatively high frequency which is divided down by the counter 178 to produce the gating signal for the gate 172, the gating signal also been applied to the timing unit 168. The timing unit 168 is operative to provide a frame synchronization signal and a phase synchronization signal for use by the synchronization generator 122.

It is to be understood that the above described embodiments of the invention are illustrative only, and that modifications thereof may occur to those skilled in the art. Accordingly, this invention is not to be regarded as limited to the embodiments disclosed herein, but is to be limited only as defined by the appended claims.

1. A modem having a transmission section and a reception section, each of the sections having a signal input port and a signal output port, wherein the transmission section comprises:
signal formatting circuitry located between the input port and the output port of the transmission section for formatting a signal applied to the input port with a desired format prior to an outputting of the signal from the output port of the transmission section; and
circuitry for insertion of a sequence of pilot symbols into a sequence of data symbols outputted by the formatting circuitry, the insertion circuitry being located between the formatting circuitry and the output port of the transmission section, the sequence of pilot symbols serving as a time reference useful in detection of a signal transmitted by the transmission section;
wherein the reception section receives a composite signal of data symbols having a prescribed format and a sequence of pilot symbols having a prescribed format which may be the same as or different from the format of the data symbols, the reception section comprising:
means for extracting the sequence of pilot symbols from the composite signal, and timing means for establishing a time base based on a time of reception of the sequence of pilot symbols; and
decoding circuitry employing the time base of the timing means for decoding the format of the received composite signal to extract data from the composite signal.

2. A modem according to claim 1 wherein the extracting means employs a replica of the sequence of pilot symbols of the transmission section for detection of the sequence of pilot symbols.

3. A modem according to claim 1 wherein the signal formatting circuitry provides a desired modulation format of any one of PSK, QAM or MSK, and multiple access of any one of TDMA, FDMA or CDMA, and a spread spectrum by DS or FH.

4. A modem according to claim 1 wherein the extracting means has a detector for detecting the sequence of pilot symbols, the detector operating by means of a filter matched to the sequence of pilot symbols or by a correlation of a received sequence of the pilot symbols against a replica of the sequence of the pilot symbols.

5. A modem according to claim 1 wherein an output stage of the formatting circuitry is a first constellation mapper, and wherein the symbol insertion circuitry includes a source of a code word followed by a second constellation mapper of the code word, the symbol insertion circuitry further comprising a multiplexer for choosing a sequence of the pilot symbols, as mapped by the second constellation mapper, followed by a sequence of the data symbols, as mapped by the first constellation mapper.

6. A modem according to claim 5 wherein the extracting means has a detector for detecting the sequence of pilot symbols, the detector operating by means of a filter matched to the sequence of pilot symbols or by a correlation of a received sequence of the pilot symbols against a replica of the sequence of the pilot symbols, and wherein the detector of the extracting means processes the constellation mapped data symbols and the constellation mapped pilot symbols to detect the sequence of pilot symbols.

7. A modem according to claim 1 wherein the formatting circuitry and the decoding circuitry are constructed in programmable circuitry, the programmable circuitry including a memory storing a plurality of programs to process any one of a plurality of predetermined signal formats.

8. A modem according to claim 7 wherein the programmable circuitry comprises a field programmable gated array or a digital signal processor or an ASIC.

9. A communication system having a transmission station and a reception station, each of the stations having a signal input port and a signal output port, wherein the transmission station comprises:
signal formatting circuitry located between the input port and the output port of the transmission station for formatting a signal applied to the input port with a desired format prior to an outputting of the signal from the output port of the transmission station; and
circuitry for insertion of a sequence of pilot symbols into a sequence of data symbols outputted by the formatting circuitry, the insertion circuitry being located between the formatting circuitry and the output port of the transmission station, the sequence of pilot symbols serving as a time reference useful in detection of a signal transmitted by the transmission station;
wherein the reception station receives a composite signal of data symbols having a prescribed format and a sequence of pilot symbols, the reception station comprising:
means for extracting the sequence of pilot symbols from the composite signal, and timing means for establishing a time base based on a time of reception of the sequence of pilot symbols, wherein the time base is suitable to train an equalization filter, to extract signal strength, and to obtain information on data modulation format for switching between formats; and
decoding circuitry employing the time base of the timing means for decoding the format of the received composite signal to extract data from the composite signal.

10. A system according to claim 9 wherein the extracting means employs a replica of the sequence of pilot symbols of the transmission station for detection of the sequence of pilot symbols.

11. A system according to claim 9 wherein the signal formatting circuitry provides a desired modulation format of any one of PSK, QAM or MSK, and multiple access of any one of TDMA, FDMA or CDMA, and a spread spectrum by DS or FH.

12. A system according to claim 9 wherein the extracting means has a detector for detecting the sequence of pilot symbols, the detector operating by means of a filter matched to the sequence of pilot symbols or by a correlation of a received sequence of the pilot symbols against a replica of the sequence of the pilot symbols.

13. A system according to claim 9 wherein an output stage of the formatting circuitry is a first constellation mapper, and wherein the symbol insertion circuitry includes a source of a code word followed by a second constellation mapper of the code word, the symbol insertion circuitry further comprising a multiplexer for choosing a sequence of the pilot symbols, as mapped by the second constellation mapper, followed by a sequence of the data symbols, as mapped by the first constellation mapper.

14. A system according to claim 13 wherein the extracting means has a detector for detecting the sequence of pilot symbols, the detector operating by means of a filter matched to the sequence of pilot symbols or by a correlation of a received sequence of the pilot symbols against a replica of the sequence of the pilot symbols, and wherein the detector of the extracting means processes the constellation mapped data symbols and the constellation mapped pilot symbols to detect the sequence of pilot symbols.

15. A modem according to claim 9 wherein the formatting circuitry and the decoding circuitry are constructed in programmable circuitry, the programmable circuitry including a memory storing a plurality of programs to process any one of a plurality of predetermined signal formats.

16. A modem according to claim 15 wherein the programmable circuitry comprises a field programmable gated array or a digital signal processor or an ASIC.

17. A modulator, suitable for use in the transmission section of a modem and in the transmission station of a communication system to prepare a signal for subsequent transmission and reception, the modulator comprising:
circuitry for encoding a signal input upon the modulator with a desired format, data of the signal being outputted by the coding circuitry as a sequence of data symbols;
circuitry coupled to an output terminal of the coding circuitry for inserting a sequence of pilot symbols into the sequence of data symbols, the sequence of pilot symbols constituting a time synchronization signal for facilitating a reception of the data symbols; and
wherein the sequence of pilot symbols is established for use in a detector at a location of reception of the data symbols, the detector operating by means of a filter matched to the sequence of pilot symbols or by a correlation of a received sequence of the pilot symbols against a replica of the sequence of the pilot symbols.

18. A modulator according to claim 17 wherein the signal formatting circuitry provides a desired modulation format of any one of PSK, QAM or MSK, and multiple access of any one of TDMA, FDMA or CDMA, and a spread spectrum by DS or FH.

19. A modulator according to claim 17 wherein an output stage of the encoding circuitry is a first constellation mapper, and wherein the symbol insertion circuitry includes a source of a code word followed by a second constellation mapper of the code word, the symbol insertion circuitry further comprising a multiplexer for choosing a sequence of the pilot symbols, as mapped by the second constellation mapper, followed by a sequence of the data symbols, as mapped by the first constellation mapper.

20. A modem according to claim 17 wherein the encoding circuitry is constructed in programmable circuitry, the programmable circuitry including a memory storing a plurality of programs to process any one of a plurality of predetermined signal formats.

21. A modem according to claim 20 wherein the programmable circuitry comprises a field programmable gated array or a digital signal processor or an ASIC.

22. A demodulator, suitable for use in the reception section of a modem and in the reception station of a communication system, wherein a signal received at the demodulator has a predetermined format and is composed of a sequence of data symbols interleaved with a sequence of pilot symbols, the sequence of pilot symbols constituting a time synchronization signal for facilitating a reception of the data symbols, the modulator comprising:
circuitry for decoding the formatted signal received at the demodulator, data of the signal being outputted by the decoding circuitry as a sequence of the data symbols;
circuitry coupled to an input terminal of the decoding circuitry for extracting the sequence of pilot symbols from the interleaved sequences of pilot and data symbols, wherein the extracting circuitry has a detector for detecting the sequence of pilot symbols, the detector operating by means of a filter matched to the sequence of pilot symbols or by a correlation of a received sequence of the pilot symbols against a replica of the sequence of the pilot symbols; and
timing circuitry responsive to the sequence of pilot symbols provided by the extracting circuitry for establishing timing signals to operate the decoding circuitry.

23. A demodulator according to claim 22 wherein the signal formatting circuitry provides a desired modulation format of any one of PSK, QAM or MSK, and multiple access of any one of TDMA, FDMA or CDMA, and a spread spectrum by DS or FH.

24. A demodulator according to claim 22 wherein the format of a signal having data symbols received at the demodulator is provided by encoding circuitry having a first constellation mapper as a final encoding stage, the sequence of pilot symbols received at the demodulator is obtained by passing a code word through a second constellation mapper prior to the interleaving of the sequence of pilot symbols with the sequence of formatted data symbols, and wherein the detector of the extracting circuitry processes the constellation mapped data symbols and the constellation mapped pilot symbols to detect the sequence of pilot symbols.

25. A modem according to claim 22 wherein the decoding circuitry is constructed in programmable circuitry, the programmable circuitry including a memory storing a plurality of programs to process any one of a plurality of predetermined signal formats.

26. A modem according to claim 25 wherein the programmable circuitry comprises a field programmable gated array or a digital signal processor or an ASIC.
